(19) United States
(12) Patent Application Publication
(10) Pub. No.: US 2007/0155475 A1
(43) Pub. Date: Jul. 5, 2007

(54) An Apparatus And A Method For Playing A Game Having A Active And Passive Modes And Wager Conversion

(76) Inventor: Alexander Gak, Fort Lee, NJ (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/380,317

(22) Filed: Apr. 26, 2006

Related U.S. Application Data
(60) Provisional application No. 60/756,142, filed on Jan. 4, 2006.

(51) Int. Cl. A63F 13/00

(52) U.S. Cl. 463/20

(57) ABSTRACT

A method and gaming apparatus for playing a game. The game including a plurality of cells and a plurality of symbols and having a result equal to one of the symbols being associated with each of the cells. A player may associate a first token corresponding to a first one of the symbols with one of the cells. A player may associate a second token corresponding to a second one of the symbols with the same cell or another cell. Multiple tokens may be placed on the same cell, increasing the wager amount. If two or more different tokens are associated with the same cell, a combination symbol is associated with the cell. The game is played and an award is given to the player if the actual result equals one the symbols associated with one of the cells.

### RELATED APPLICATIONS

The present invention claims priority to U.S. Provisional Patent Application Ser. No. 60/756,142, filed on Jan. 4, 2006 (attorney docket no. 60,708-004), which is hereby incorporated by reference in its entirety.

### FIELD OF THE INVENTION

The present invention relates to a game upon which a player may make a wager. The game is playable in an active mode or a passive mode and allows the player to convert one type of wager into another type of wager.

### BACKGROUND OF THE INVENTION

Various games already exist in a gaming arena. For example, U.S. Pat. No. 6,896,264 offers a dice game that uses two six-sided dice and with a payout for either a single roll or a wager where a winner is determined two consecutive rolls. U.S. Pat. No. 6,893,019 offers a dice game that uses three six-side dice to determine a winning wagers. The game offers various payout odds for each wager and a winning wager is determined by the sum of the single die, a pair of dice, or all three dice, on a single roll of all three dice.

There are generally two types of gaming experiences offered on a typical casino floor, namely, the table game experience and the slot machine experience. The major difference between the two is the ability to influence the outcome of the game that is present in table games. For those, who are willing to give up that ability and leave it all to chance, the slot games offer such an opportunity. Table games and slot machines can be, therefore, be thought of in terms of active and passive gambling, respectively.

Unfortunately, the current reality is such that whenever one wants to change the style of playing from passive to active, for example, one has to physically move to a different gaming apparatus that offers the desired gaming experience. Furthermore, few of the prior art games ever are successful because they often have complex wagering schemes or are too simple to captivate a player.

The present invention is aimed at one or more of the problems as set forth above.

### SUMMARY OF THE INVENTION

In one aspect of the present invention, a method for playing a game is provided. The game includes a plurality of cells and a plurality of symbols. The has a result equal to one of the symbols being associated with each of the cells. The method includes the steps of providing a first token corresponding to a first one of the symbols, allowing a player to associate the first token with one of the cells, and creating a first wager on the one cell. The first wager has a wager amount and a wager symbol. The wager amount is a function of a stake associated with the first token. The wager symbol is the first one of the symbols. The method further includes the steps of playing the game and arriving at an actual result and providing an award to the player if the actual result of the one cell is equal to the wager symbol as a function of the wager amount, any cells adjacent to the one cell which have an actual result equal to the wager symbol, and a predetermined paytable.

In a second of the present invention, a gaming apparatus for playing a game using a plurality of symbols is provided. The game apparatus includes a display, a player interface, and a game controller. The display displays a plurality of cells. The game has an actual result equal to one of the symbols being associated with each of the cells. The player interface provides a first token corresponding to a first one of the symbols and allows a player to associate the first token with one of the cells. The first token has an associated first stake. The game controller creates a first wager on the one cell, plays the game and arrives at the actual result. The first wager has a wager amount and a wager symbol. The wager amount is a function of the first stake. The wager symbol is the first one of the symbols. The game controller provides an award to the player if the actual result of the one cell is equal to the wager symbol as a function of the wager amount, any cells adjacent to the one cell which have an actual result equal to the wager symbol, and a predetermined paytable.

In a third aspect of the present invention, a method for playing a game is provided. The game includes a first cell and a plurality of symbols and has an actual result equal to one of the symbols being associated with the first cell. The method includes the steps of providing a first token corresponding to a first one of the symbols, allowing a player to associate the first token with the first cell, providing a second token corresponding to a second one of the symbols, and allowing the player to associate the second token with the first cell. The first token has an associated first stake. The second token has an associated second stake. The method also includes the steps of creating a first wager on the first cell having a wager amount and a wager symbol, playing the game and arriving at an actual result. The wager amount is a function of the first stake if the first token is associated with the first cell and/or a function of the second stake of the second token is associated with the first cell. The wager symbol is the first one of the symbols if only the first token is associated with the first cell, the second one of the symbols if only the second token is associated with the first cell, and a combined symbol if the first and second tokens are associated with the first cell. The method further includes the step of providing an award to the player, if the actual result is equal to the wager symbol, as a function of the wager amount and a predetermined paytable.

In a fourth aspect of the present invention, a gaming apparatus is provided for playing a game, the game including a first cell and a plurality of symbols, the game having an actual result equal to one of the symbols being associated with the first cell. The game apparatus includes a display, a player interface and a game controller. The display displays the game including at least one rotatable reel having a plurality of symbols. The player interface provides a first token corresponding to a first one of the symbols and allows a player to associate the first token with the first cell. The first token has an associated first stake. The player interface provides a second token corresponding to a second one of the symbols and allows the player to associate the second token with the first cell. The second token having an associated second stake. The controller is coupled to the display and player interface for creating a first wager on the first cell. The first wager has a wager amount and a wager symbol. The wager amount is a function of the first stake if the first token is associated with the first cell and/or a function of the second stake of the second token is associated with the first cell. The wager symbol is the first one of the symbols if only the first token is associated with the first cell, the second one of the symbols if only the second token is associated with the first cell, and a combined symbol if the first and second tokens are associated with the first cell. The game controller plays the game and arrives at an actual result and provides an award to the player, if the actual result is equal to the wager symbol, as a function of the wager amount and a predetermined paytable.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1A is a block diagram of a gaming machine for providing a game with an active mode or a passive mode and which may allow the player to convert one type of wager into another type of wager, according to an embodiment of the present invention;

FIG. 1B is a flow diagram of a first method for playing a game, according to an embodiment of the present invention;

FIG. 1C is a flow diagram of a second method for playing a game, according to another embodiment of the present invention;

FIG. 2 is a diagrammatic illustration of a first screen shot of a game, according to an embodiment of the present invention;

FIG. 3 is a diagrammatic illustration of another screen shot of the game of FIG. 2;

FIG. 4 is a diagrammatic illustration of another screen shot of the game of FIG. 2;

FIG. 5 is a diagrammatic illustration of another screen shot of the game of FIG. 2;

FIG. 6 is a diagrammatic illustration of another screen shot of the game of FIG. 2;

FIG. 7 is a diagrammatic illustration of another screen shot of the game of FIG. 2;

FIG. 8 is a diagrammatic illustration of another screen shot of the game of FIG. 2;

FIG. 9 is a diagrammatic illustration of another screen shot of the game of FIG. 2;

FIG. 10 is a diagrammatic illustration of another screen shot of the game of FIG. 2;

FIG. 11 is a diagrammatic illustration of another screen shot of the game of FIG. 2;

FIG. 12 is a diagrammatic illustration of another screen shot of the game of FIG. 2;

FIG. 13 is a diagrammatic illustration of another screen shot of the game of FIG. 2;

FIG. 14 is a diagrammatic illustration of another screen shot of the game of FIG. 2;

FIG. 15 is a diagrammatic illustration of another screen shot of the game of FIG. 2;

FIG. 16 is a diagrammatic illustration of another screen shot of the game of FIG. 2;

FIG. 17 is a diagrammatic illustration of another screen shot of the game of FIG. 2;

FIG. 18 is a diagrammatic illustration of another screen shot of the game of FIG. 2;

FIG. 19 is an exemplary screenshot from an exemplary game, according to another embodiment of the present invention; and

FIG. 20 shows an exemplary pay table.

### DETAILED DESCRIPTION OF THE INVENTION

With reference to the drawings, wherein like numerals indicate corresponding parts throughout the several views, and in operation, the present invention provides a gaming apparatus 2 and method for the play of a game. The gaming apparatus 2 may be embodied as a table game, or a console or in a game cabinet, or embodied in a computer software program playable on a computer. The game may be provided in a suitable environment such as a casino, or may be provided in a public location such as a bar or restaurant. The game may also be provided over a network, such as the internet.

For the purposes of illustration and discussion, a computer software embodiment is disclosed and discussed. However, the present invention is not limited to such.

The gaming apparatus 2 includes a display 4, a player interface 6, and a game controller 8. In the computer software embodiment, the gaming apparatus 2 is a computer, such as a personal computer or a PDA. The player interface 6 may include a keyboard and/or mouse and/or touchscreen sensor (not shown) or other suitable input device. The game controller 8 may include the computers microprocessor (not shown).

In a first aspect of the present invention, the gaming apparatus 2 allows a player to make a wager and play a game as described below. The game utilizes a plurality of symbols. The display 4 is used to display a plurality of cells 23 (see below). The game has an actual result which is equal to one of the symbols being associated with each of the cells.

As described below, the player interface 6 allows the player to make wagers. The player interface 6 provides a tokens 26, which may be in the form of virtual “chips”. Each token or chip 26 corresponds to one of the symbols. The player interface 6 allows the player to associate one of the tokens with one of the cells 23. Each token or chip 26 has an associated amount or stake. The stake or amount may be expressed in terms of a monetary amount, e.g., S0.25, or a number of credits.

The game controller 8 is coupled to the display 4 and the player interface 6. In response to the player associated one or more of the tokens 26 with one of the cells 23, the game controller 8 creates wager(s). As described below, the player may:

associate one or more of the same tokens 26 with the same cell 23,

associate the same token 26 with more than one cell 23, and,

associate different tokens 26 with the same or multiple cells. cell 23 chips

A wager has a wager amount and a wager symbol. The wager amount is the sum of all token amounts or stakes of all of the tokens 26 associated with all of the cells.

For example, if the player associates a single token having a first stake or amount to a first cell 23, the wager amount is equal to the first stake or token amount. However, if the player associated the same token to a cell N times, then the wager amount is N× the token amount.

Additionally, if the player associates another token having a second stake or amount to another cell 23, then the wager amount is equal to the sum of an amount due to the first token being associated with the first cell and an amount due to the second token being associated with the another cell.

If the two different tokens 26 are associated with a single cell 23, then a composite symbol is formed and associated with the cell 23 (see below).

After the wager is created and the player initiates the game, the game controller 8 plays the game and randomly establishes the actual result. In one embodiment, the actual result may be randomly establishing using the computer program application or may be established using a separate random number generator as is known in the art. The random number generator or computer program application may generate a random number out of a total number of possible outcome numbers to establish the actual outcome. It should be noted that although there may be an equal chance of a particular number, and thus a particular outcome, being generated, the probability associated with the possible outcomes of the outcome generator might not be equal.

The game control 8 provides an award (in terms of a monetary amount or a number of credits) if the actual result of the cell (with an associated token or chip 26) is equal to the wager symbol as a function of the wager amount, any cells adjacent to the one cell which have an actual result equal to the wager symbol, and a predetermined paytable. An exemplary pay table 40 is shown in FIG. 20.

In another words, if the player associates one of a first tokens 26, having a stake or amount of $0.25 with a first cell 26 and the actual result includes the symbol associated with the first token in the first cell, then the player will be paid an award. The award will include an amount for the first cell, plus an amount for any adjacent cell that also includes the same symbol. The amount of the award will be dependent upon the symbol, the wager amount, and the paytable.

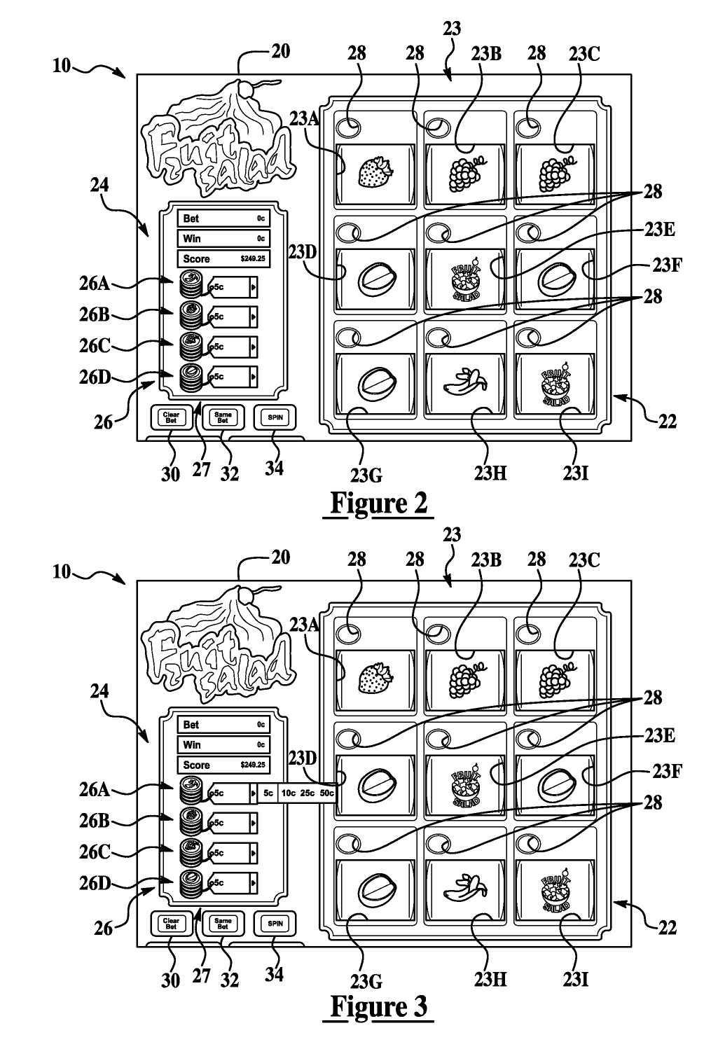

In one aspect of the present invention, the cells 23 are arranged in a grid. The grid may be rectangular or square. In one embodiment, as shown in FIGS. 2-18, the gaming apparatus 2 includes a 9 cells 23A-23I arranged in a 3×3 grid. However, other sizes, such as a 3×5 grid may be used.

Alternatively, other grid shapes may also be used, such as triangles, diamonds, hexagons, etc. . . .

In one aspect, each cell 23 is rectangular, i.e., having 4 sides. Other cells 23 are adjacent to a cell if the cells 23 share a common side. Thus, a cell could have at most 4 adjacent other cells 23. However, it should be noted that other cell shapes may be used. For example, each cell 23 may be in the shape of a hexagon, i.e., having 4 sides. Thus, at most, a hexagon shaped cell 23 could have 6 adjacent cells.

In one aspect of the present invention, each cell 23 represents or has an associated reel 22. Each reel 22 has a plurality of reel position. Each reel position has an associated symbol. It should be noted that in a mechanical reel system, each reel has a set number of reel position which will generally have a fixed symbol. However, in a video slot type implementation, the number of reel positions and/or the symbols of each reel position on each reel may not be fixed or set. Rather, the number of reel positions or the symbol associated with a reel position may vary depending on the odds and paytable for a specific implementation.

As discussed more full below, a second token 26 corresponding to a second one of the symbols may provided. The second token 26 has an associated second stake or amount. The player may associate the second token 26 with another one of the cells 23 or with the same cell 23 with which the first token 26 is associated.

If two or more different tokens 23 are associated with the same cell 23, the two (or more) different tokens are converted into a third or composite symbol (see below). In one embodiment, the composite symbol is treated the same way as the other symbols with regard to establishing a win, i.e., whether an award is to be awarded. However, the composite symbol will generally have a different paytable, e.g., lower probability with increased payout or increased probability with decreased payout.

In another aspect of the present invention, the game controller 8 and the player interface 6 allow the player to modify the stake or amount associated with each token or chip 26. With reference to FIGS. 2 and 3, in one embodiment, the player interface 6 and display 4 provides a window 27 for each token 26A, 26B, 26C, 26D with the current respective stake or amount. The window 27 includes an arrow which, upon actuation, provides a menu or list of the possible stakes or amount which may be associated with the tokens 26.

In still another aspect of the present invention, the game controller 8 allows the player to repeat the same wager without having to create the wager repeatedly.

In one embodiment, as shown in FIG. 2, the player interface 6 may include a clear bet button 30, a same bet button 32, and a spin button 34. Actuation of the clear bet button 30 removes any wagers, i.e., the associated of any tokens 26 with the cells 23. Actuation of the same bet button 32 initiates the game and spins the reels 22 using the same bet as the last game. Actuation of the spin button 34 initiates the game using a newly created wager.

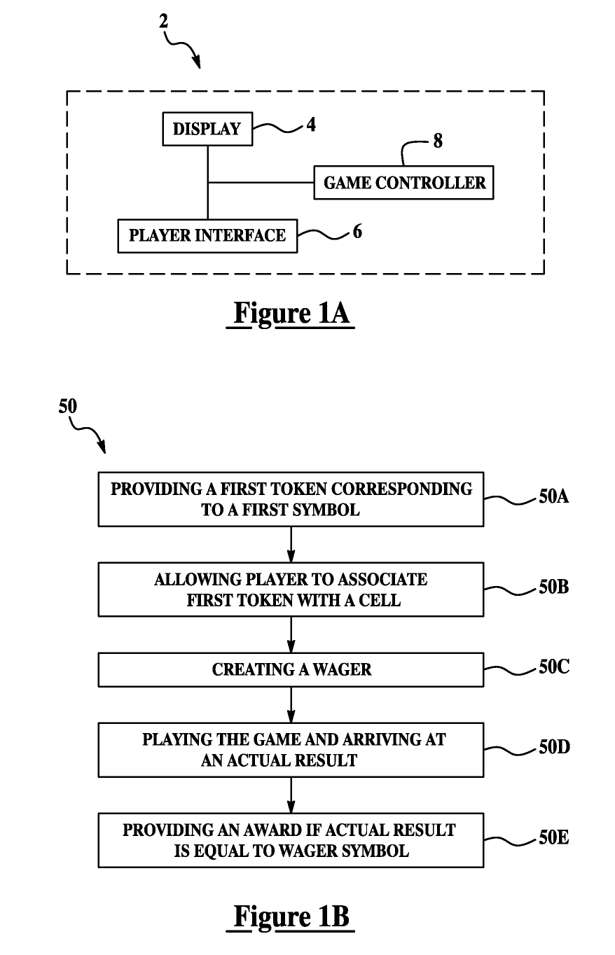

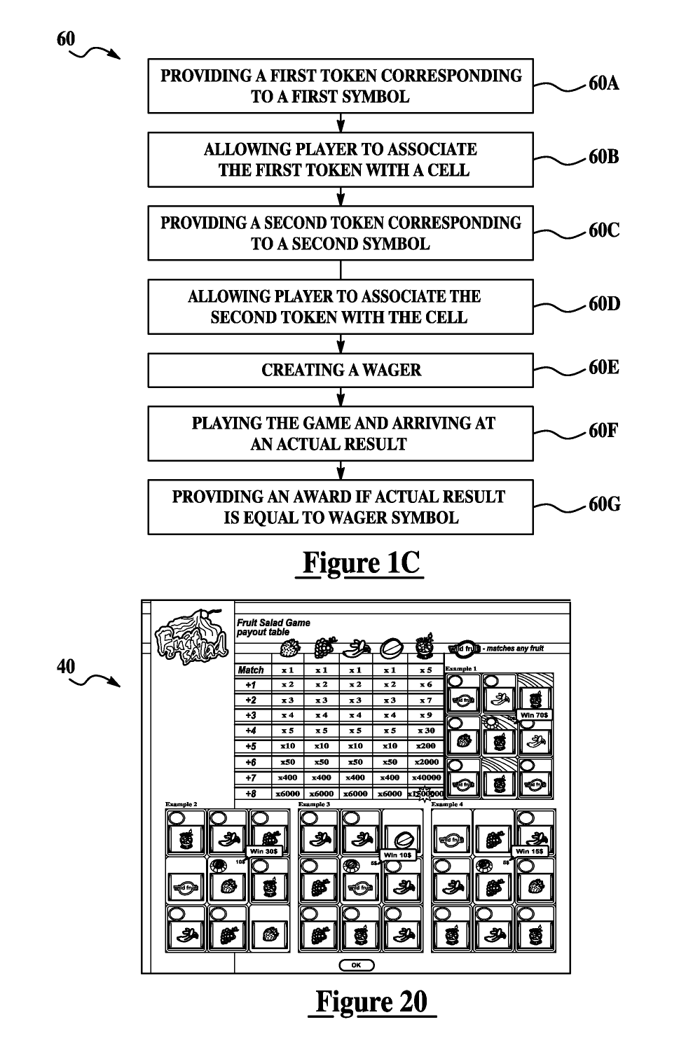

With specific reference to FIG. 1B, a method 50 for playing a game according to one embodiment of the present invention is shown. The game includes a plurality of cells and a plurality of symbols. The game has a result equal to one of the symbols being associated with each of the cells.

In a first step 50A, a first token 26 corresponding to a first one of the symbols is provided. The first token has an associated first stake or amount.

In a second step 50B, a player is allowed to associate the first token with one of the cells.

In a third step 50C, a wager is created on the one cell. The wager has a wager amount and a wager symbol. The wager amount is a function of the first stake. The wage symbol is the first one of the symbols.

In a fourth step 50D, the game is played and an actual result is established.

In a fifth step an award is provided to the player if the actual result of the one cell is equal to the wager symbol as a function of the wager amount, any cells adjacent to the one cell which have an actual result equal to the wager symbol, and a predetermined paytable.

In one embodiment, the player is allowed to associate the first token with other cell(s) to create additional wager(s).

In another embodiment, the player is allowed to convert the first wager to a second wager by adding or associated another token 26 to the same cell 23, thereby creating a composite symbol.

In one embodiment, the player may associate the first token with the one cell multiple times. The wager amount is then a function of the first stake and the number of times the first token is associated with the one of the cells.

In another aspect of the present invention, the player interface 6 provides first and second tokens 26A, 26B. The first token corresponds to a first one of the symbols and has an associated first stake or amount. The second token correspond to a second one of the symbols and has an associated second stake or amount. The player interface 6 allows a player to associate the first and the second token 26A, 26B with one of the cells 23. The controller 8 creates a wager on the cell. The wager amount associated with the wager is a function of the first stake if the first token is associated with the first cell and/or a function of the second stake of the second token is associated with the first cell. The wager symbol is the first one of the symbols if only the first token is associated with the first cell, the second one of the symbols if only the second token is associated with the first cell, and a combined symbol if the first and second tokens are associated with the first cell.

The game controller 8 plays the game and randomly arrives or establishes an actual result. An award is provided to the player if the actual result is equal to the wager symbol, as a function of the wager amount and a predetermined paytable.

As described above, the award may also be a function of any cells adjacent to the first cell which have an actual result equal to the wager symbol.

With reference to FIG. 3, in another aspect of the present invention a method 60 for playing a game is provided. The game includes a first cell and a plurality of symbols. The game has an actual result equal to one of the symbols being associated with the first cell. In a first step 60A, a first token corresponding to a first one of the symbols and having an associated first stake is provided. In a second step 60B, a player is allowed to associate the first token with the first cell. In a third step 60C, a second token corresponding to a second one of the symbols and having an associated second stake is provided. In a fourth step 60D, the player is allowed to associate the second token with the first cell. In a fifth step 60E, a first wager on the first cell is created. The first wager has a wager amount and a wager symbol.

The wager amount is a function of the first stake if the first token is associated with the first cell and/or a function of the second stake of the second token is associated with the first cell. The wager symbol is the first one of the symbols if only the first token is associated with the first cell, the second one of the symbols if only the second token is associated with the first cell, and a combined symbol if the first and second tokens are associated with the first cell.

In a sixth step 60F, the game is played and an actual result is established.

In a seventh step 60G, an award is provided to the player if the actual result is equal to the wager symbol as a function of the wager amount and a predetermined paytable.

With respect to FIGS. 2-18, screen shots of an exemplary game called “Fruit Salad” 10 are shown. The game concept “Fruit Salad” is for discussion purposes only. The game 10 includes a display 20 with a plurality of rotating reels 22. In the illustrated embodiment, the rotating reels 22 are displayed in a grid of cells 23.

A 3×3 grid is disclosed, although, a grid of different dimensions, such as, but not limited to, 3×5 or 4×5 or 5×4 may be used. The grid includes nine cells 23A-23I. Each rotating reel 22 has a plurality of positions having a symbol from a symbol set. For example, the symbol set from the “Fruit Salad” may include, but not limited to, a strawberry symbol, a grapes symbol, a watermelon symbol, a banana symbol, a wild or “wild fruit” symbol, and a composite, i.e., fruit salad, symbol. More or alternative symbols may also be used. As explained below, the fruit salad symbol is a composite symbol made by a combination of two or more of the other symbols.

A player plays the game by placing one or more wagers and starting the game. When the game is begun, the reels 22 spin and then stop. After the reels 22 stop, the player may be paid a payout as a function of the wager(s) and the symbols or combinations of symbols which are displayed (see below).

Other symbol sets, consistent with a particular game theme or concept may also be used. For example, another game concept is “Tool Box”. The symbols for the Tool Box game may include symbols for individual tools and may include a tool box composite symbol.

In one embodiment, each reel 22 has a predetermined number of positions with an associated, predetermined symbol from the symbol set. Each reel 22 may be a mechanical reel controlled by a controller or computer or may be a virtual reel.

In another embodiment, the reels 22 are virtual reels. Each reel 22 has a number of positions, which may be predetermined or may be variable. The number of positions on each reel may also vary between reels. However, the symbol associated with each position is not set. In other words, the outcome of each reel 22, i.e., the symbol shown in the grid when the reel stops spinning, is randomly chosen. The reels 22 may be animated to give the appearance that the reels 22 are spinning. Choosing random outcomes to achieve predetermined payout odds is well known in the art and therefore not further discussed.

In one aspect of the present invention, the game 10 provides two modes: an active mode and a passive mode. In the active mode, the player actively places wager(s) on the grid in an attempt to influence the outcome of the game. In the passive mode, once the player has created at least one wager, the player may continue to play the same wager(s) by simply selecting the “same bet” option.

In the passive mode, the player may create a desired wager or set of wagers and continuously replay the same wager(s). Alternatively, the game may provide a set or sets of predetermined wager(s). The player need only select the set of desired wagers to play the game.

The display 20 includes a wager area 24. The wager area 24 displays the current bet or wager, the payout or win for the last game, and the player's score. The wager, payout or score may be in terms of a monetary unit or in terms of a number of credits or tokens.

The wager area 24 includes a plurality of wager devices 26. In the illustrated embodiment, the wager area 24 includes a wager device 26A, 26B, 26C, 26D for each fruit symbol, i.e., the banana symbol, the strawberry symbol, the grapes symbol, and the watermelon symbol, respectively. In the illustrated embodiment, each wager device 26 includes a stack or representation of a stack of chips bearing the corresponding symbol.

Each wager device 26 allows the player to choose the amount of each wager via a menu. For example, as shown in FIG. 3, each wager device 26 allows the player to chose a wager of 5, 10, 25, or 50 cents. It should be noted that these wager amounts are exemplary only and the present invention is not limited to any set of wager amounts. The current choice is displayed in each wager device 26, e.g., 5 cents is displayed in each wager device in FIG. 2.

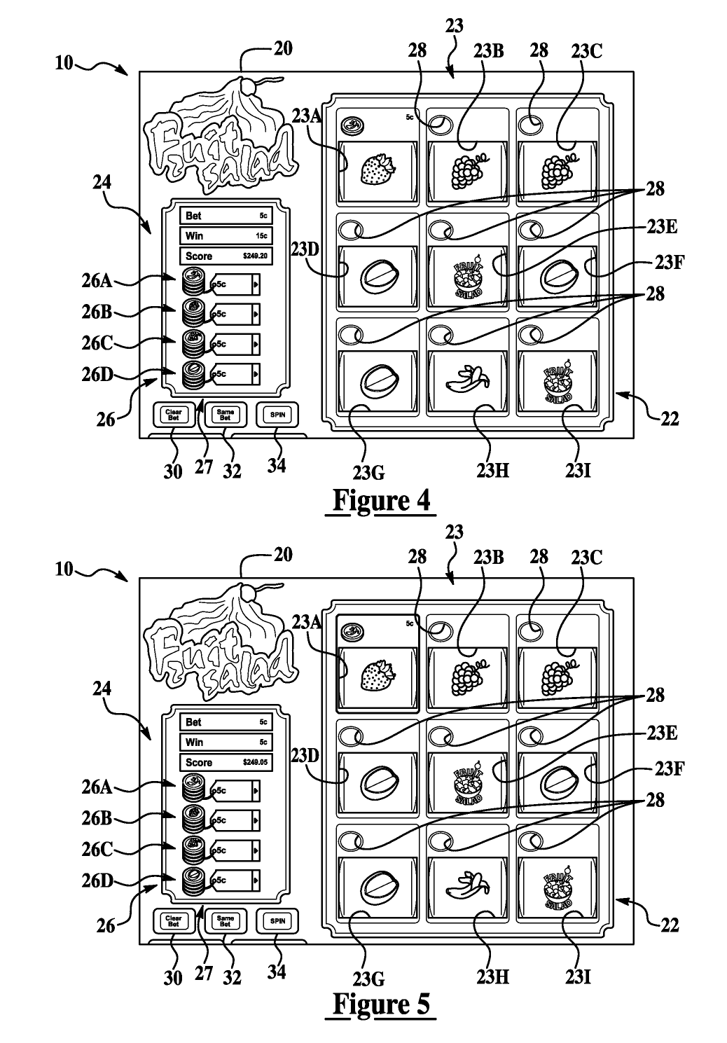

Each cell in the grid includes a wager position 28. The player places one or more wagers by selecting one of the wager devices 28 and placing a chip from the stack of chips in the wager position 28 on one of the cells. FIG. 4 shows a “banana” chip in the wager position 28 of the top left cell. This is a single wager.

With respect to this wager, if the player starts the game after making this wager, the reels 22 are spun. With reference to FIG. 5, once the reels 22 stop, the player is paid out if the resulting symbol in the cell containing the wager has the same symbol (or a wild symbol—the “wild fruit” symbol) as the chip in the wager position 28. As shown in FIG. 5, the total amount wagered by the player was 5 cents. Since the if the symbol in the cell matches the chip symbol, then a payout of 5 cents is paid to the player.

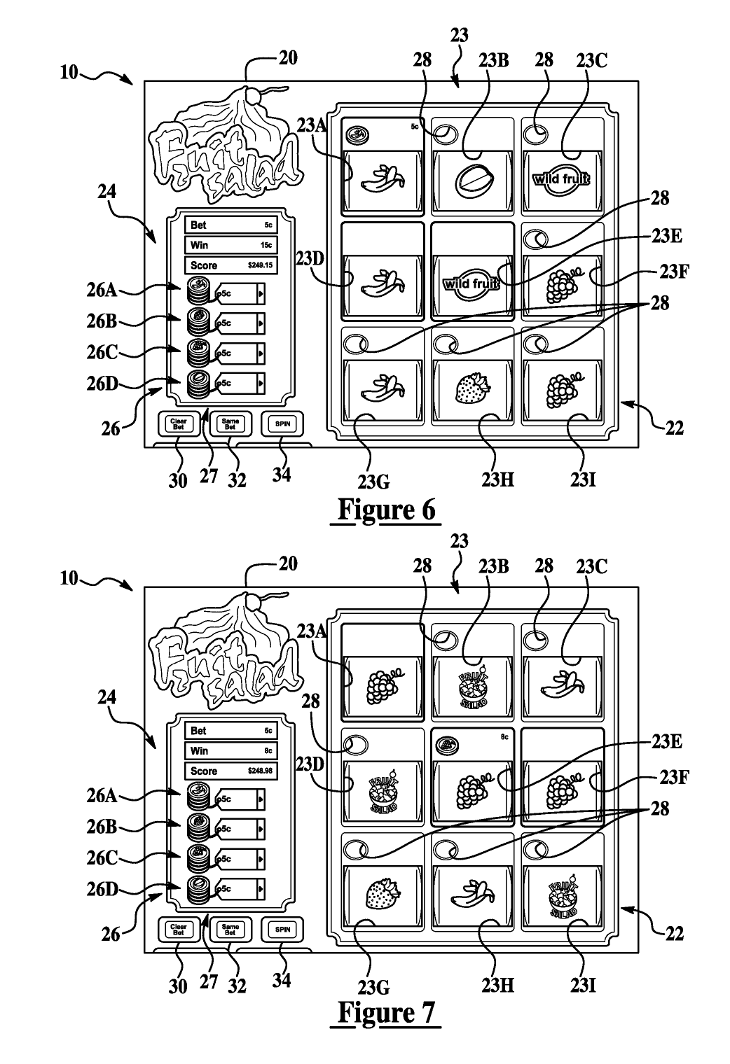

Additionally, with reference to FIG. 6, the payout may be increased if, in addition to the matching symbol in the cell the wager was made, adjacent cell(s) contain a matching symbol or a wild symbol. As shown, again a single wager 5 cents has been made in the top left cell. After the reels 22 are spun, matching symbols appear in the top left cell, the adjacent cell below, and the center cell. Thus, the payout is increased, in this example, to 15 cents.

FIG. 7 shows a 5 cent wager with a “grapes” chip in the center cell. Since a matching symbol appears on the center cell and two adjacent cells, the payout was increased to 15 cents.

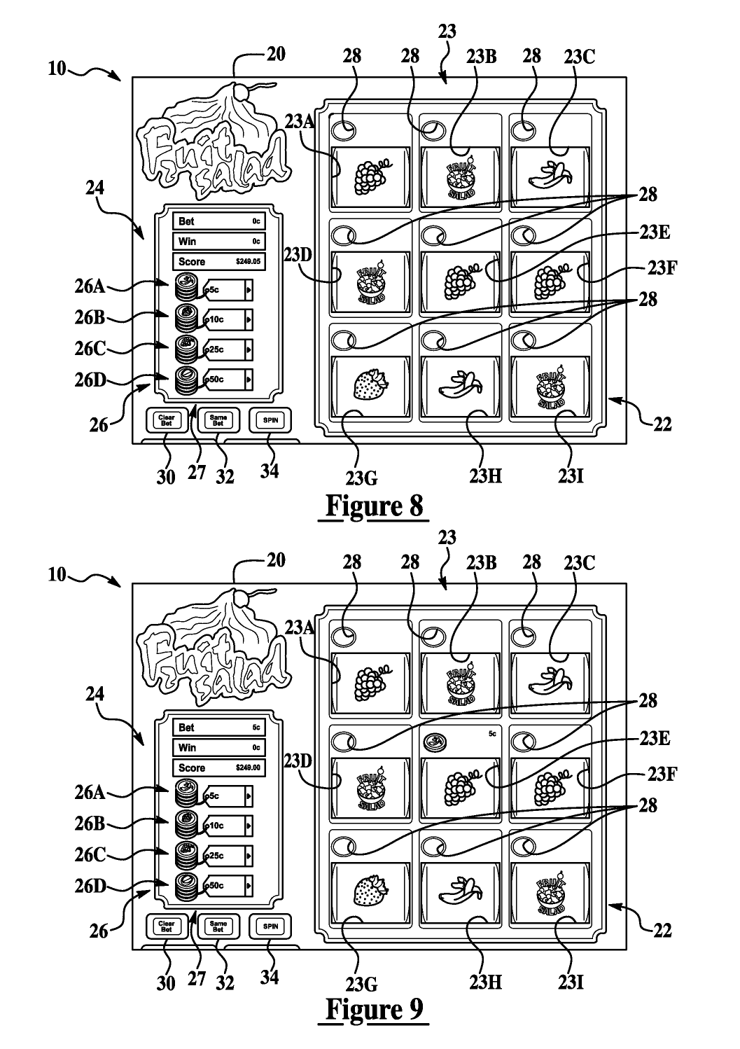

With reference to FIGS. 8-9, the player may create complex wager types by modifying the amounts of wagers for each symbol type. For example, the player may make each banana, strawberry, grape, and watermelon chip worth 5, 10, 25, and 50 cents, respectively. Of course, other combinations may also be used. Thus, the total amount a player has wagered will depend on the number and type of chips the player had placed on the cells.

The player may additionally place large wagers on a single cell by placing more than of the same type of chip on the same cell. However, the total amount of wager per cell or per game may be limited to a predetermined amount.

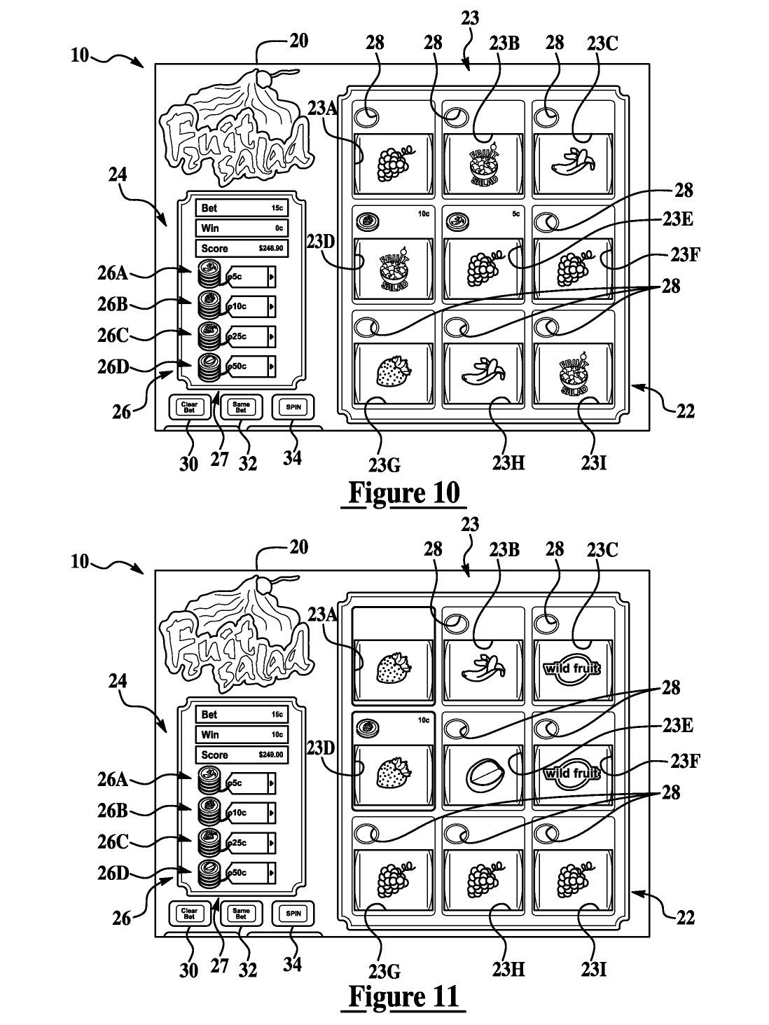

For example, with reference to FIG. 10, the player has placed a strawberry chip with a value of 10 cents on one cell and a banana chip with a value of 5 cents on another cell. Thus, there are two separate wagers and a total amount wagered of 15 cents.

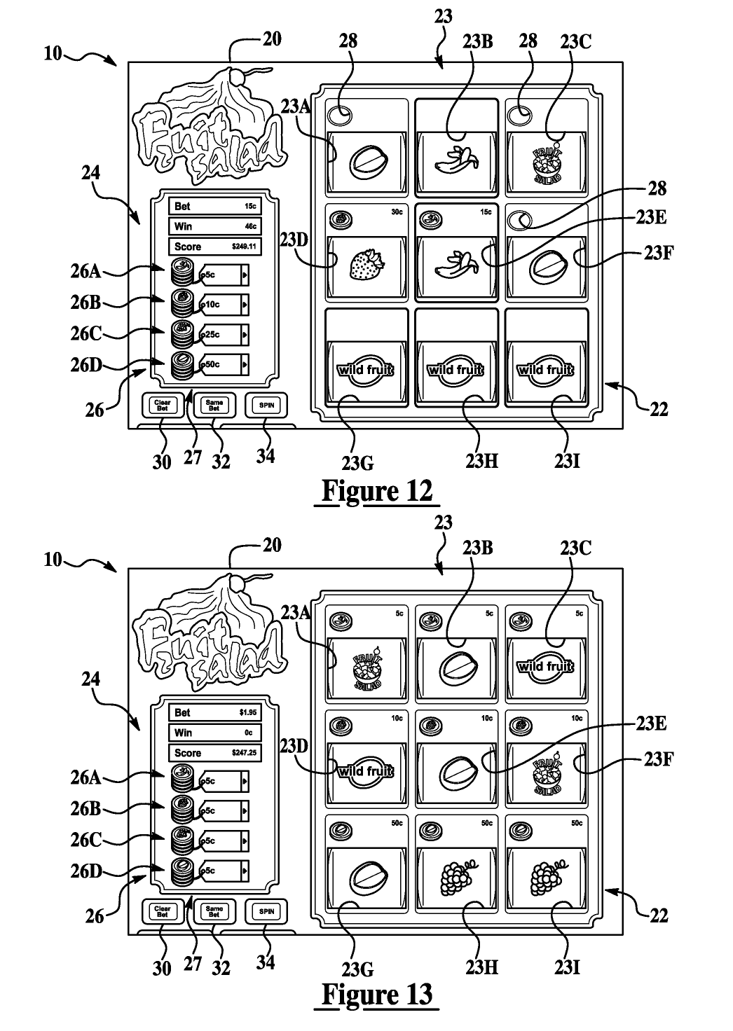

After the game has played, the player is paid a payout based on either wager. With reference to FIG. 11, for example, the result includes a strawberry symbol in the left, middle cell and the top, left cell. Thus, there are two matches for the strawberry. With reference to FIG. 12, in addition to the payout for the strawberry symbol match, if a banana symbol results in the center cell (and any adjacent cell) an additional payout may be made. It should be noted that the payout for any wager is not necessarily a multiple of the wager made, but will be determined using a predetermined pay table.

The wager 26 area includes a clear bet button 30, a same bet button 32, and a spin button 34. The clear bet button 30 removes any chips placed in the wager positions 29. The same bet button 32 repeats the same wagers from the previous game and starts the reels spinning. The spin button 34 is used to start the game after a new wager or wagers are placed.

As mentioned above, the player may make complex wager patterns. For example, the player may re-create or simulate paylines, e.g., three horizontal paylines.

Additionally, once one or more wagers are placed, the player may passively place the same wagers in multiple, continuous games by selecting the same bet button 32.

In another aspect of the present invention, the player may change a single wager, i.e., a single chip type on a cell into a composite wager by placing chips of different type in the same wager position 28 on the same cell.

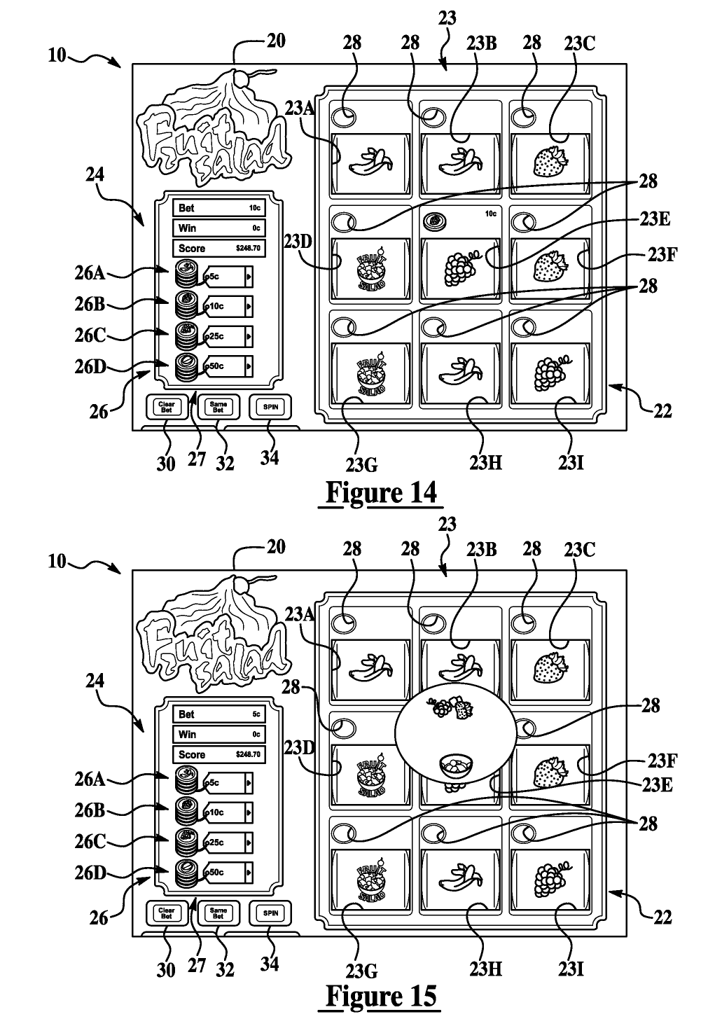

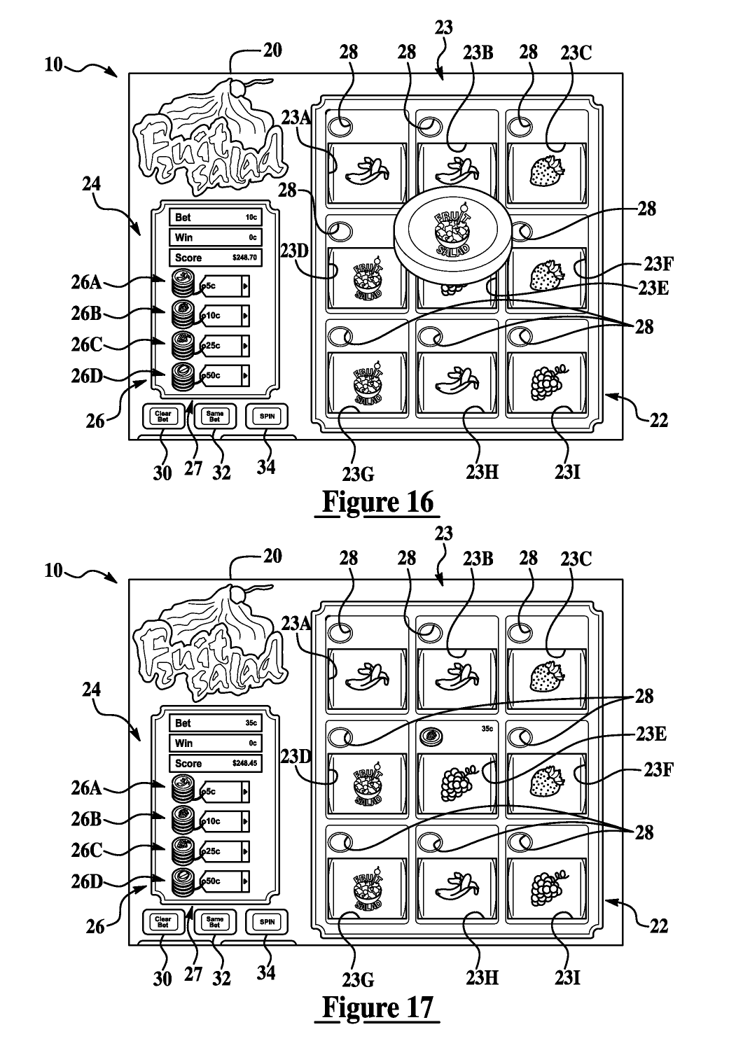

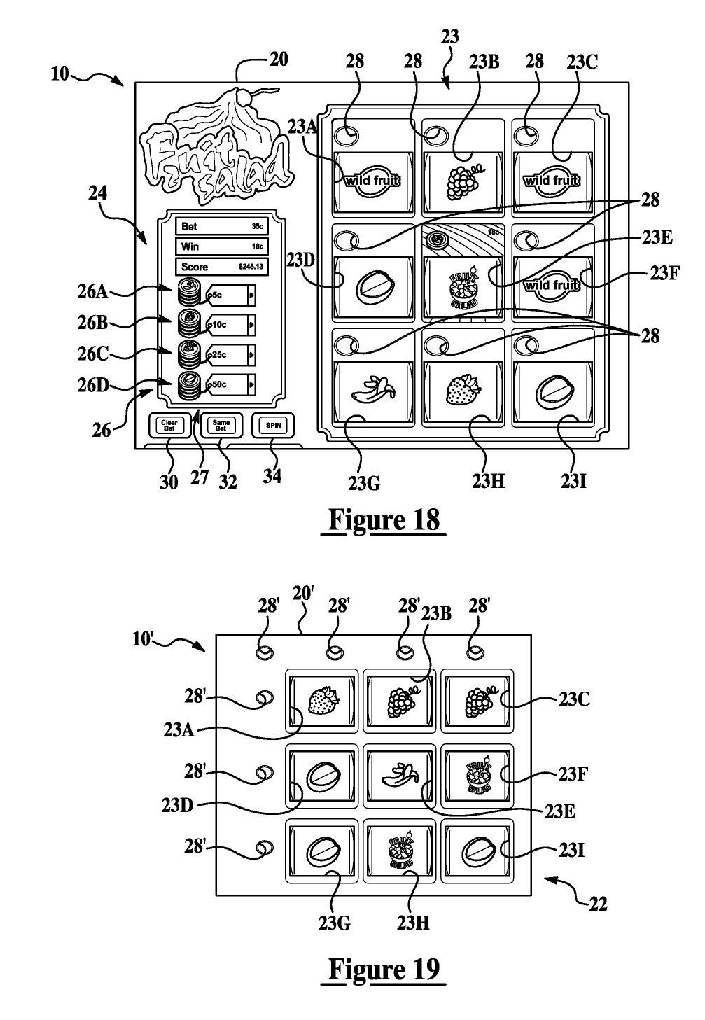

For example, in FIG. 14, the player has placed a single strawberry chip (having a value of 5 cents) on the center cell. If the player also places a chip of another type on the same cell, a composite wager is made. For example in the illustrated embodiment, if a grape chip is placed on the same cell, an animation is displayed (see FIGS. 15 and 16) which shows strawberries and grapes being sliced up and mixed in a bowl. Thus, the two single chips are combined to form a “fruit salad”. A fruit salad chip is displayed in the wager position 28 of the center cell (see FIG. 17). After the reels have been spun, the player is paid a payout if the respective cell contains a fruit salad symbol (see FIG. 18).

In one embodiment, composite wagers and single wager types may be made (on different cells) in the same game.

With reference to FIG. 19 (wherein like elements are labeled the same), a screenshot of a portion of an alternative display 20′ is shown. The display 20′ includes the rotating wheels 22 and a plurality of wager positions 28′ which are located outside of the individual cells. The wager positions 28′ operate in a manner similar to the wager positions 28 discussed above, i.e., the wager positions 28′ are used by the player to place wagers. In the illustrated embodiment, wagers are placed on a wager position by dragging or placing a chip in the desired wager position 28′. However, the wager positions 28′ are not associated with a single cell, but rather with a predefined set of cells. For example, as shown in FIG. 19, the cells are arranged in a 3×3 grid. There are three wager positions 28′ on the top, one above each column and three wager positions 28′ along the side, one adjacent each row. A seventh wager position 28′ is adjacent a corner. In the illustrated embodiment, the column wager positions 28′ are associated with vertical paylines, each corresponding to one of the columns, the side wager positions 28′ are associated with horizontal paylines, each corresponding to one of the rows, and the corner wager position is associated with a diagonal payline. Other combinations or patterns of cells may also be used (in addition or as substitutes) as a “payline” and associated with a wager position 28.

The player may place single or composite wagers on the predetermined paylines in the same manner as described above. If after the game is played, a matching symbol appears on each cell of the corresponding payline (or pattern), then the player is paid a payout based on a predetermined payout.

Implementations of the game may include wager positions 28 in one or more of the cells and/or wager positions 28′ associated with predetermined sets of cells, i.e., “paylines”.

In one embodiment, the set of cells associated with one or more the wager positions 28′ are fixed. In another embodiment, the player may define or modify the cells associated with one or more of the wager positions 28′.

FIG. 20 shows an exemplary pay table.

Obviously, many modifications and variations of the present invention are possible in light of the above teachings. The invention may be practiced otherwise than as specifically described within the scope of the appended claims.

What is claimed is:

1. A method for playing a game, the game including a plurality of cells and a plurality of symbols, the game having a result equal to one of the symbols being associated with each of the cells, comprising:
providing a first token corresponding to a first one of the symbols, the first token having an associated first stake;
allowing a player to associate the first token with one of the cells;
creating a first wager on the one cell, the first wager having a wager amount and a wager symbol, the wager amount being a function of the first stake, the wager symbol being the first one of the symbols;
playing the game and arriving at an actual result;
providing an award to the player if the actual result of the one cell is equal to the wager symbol as a function of the wager amount, any cells adjacent to the one cell which have an actual result equal to the wager symbol, and a predetermined paytable.

2. A method, as set forth in claim 1, where the cells are arranged in a rectangular grid.

3. A method, as set forth in claim 1, wherein each cell represents a reel having a plurality of reel positions, each reel position having an associated one of the symbols.

4. A method, as set forth in claim 1, wherein the game is implemented as a video or mechanical slot reel game.

5. A method, as set forth in claim 1, wherein the game is implemented in a computer program playable on a computer.

6. A method, as set forth in claim 1, including the step of allowing the player to associate the first token with other of the cell(s) to create additional wager(s).

7. A method, as set forth in claim 1, including the steps of:
providing a second token corresponding to a second one of the symbols, the second token having an associated second stake; and
allowing the player to associate the second token with the first cell, the first wager amount being a function of the first stake if the first token is associated with the first cell and/or a function of the second stake of the second token is associated with the first cell, the wager symbol being the first one of the symbols if only the first token is associated with the first cell, the second one of the symbols if only the second token is associated with the first cell, and a combined symbol if the first and second tokens are associated with the first cell.

8. A method, as set forth in claim 1, including the step of allowing the player to associate the first token with the one of the cells multiple times, the wager amount being a function of the first stake and the number of times the first token is associated with the one of the cells.

9. A method, as set forth in claim 1, including the step of allowing the player to modify the first stake.

10. A method, as set forth in claim 1, including the step of allowing the player to play the game again using the same wager.

11. A gaming apparatus for playing a game using a plurality of symbols, comprising:
a display for displaying a plurality of cells, the game having an actual result equal to one of the symbols being associated with each of the cells;
a player interface for providing a first token corresponding to a first one of the symbols, the first token having an associated first stake, and for allowing a player to associate the first token with one of the cells;
a game controller coupled to the display and player interface for creating a first wager on the one cell, the first wager having a wager amount and a wager symbol, the wager amount being a function of the first stake, the wager symbol being the first one of the symbols, for playing the game and arriving at the actual result, and for providing an award to the player if the actual result of the one cell is equal to the wager symbol as a function of the wager amount, any cells adjacent to the one cell which have an actual result equal to the wager symbol, and a predetermined paytable.

12. A gaming apparatus, as set forth in claim 11, where the cells are arranged in a rectangular grid.

13. A gaming apparatus, as set forth in claim 11, wherein each cell represents a reel having a plurality of reel positions, each reel position having an associated one of the symbols.

14. A gaming apparatus, as set forth in claim 11, wherein the game is implemented as a video or mechanical slot reel game.

15. A gaming apparatus, as set forth in claim 11, wherein the game is implemented in a computer program playable on a computer.

16. A gaming apparatus, as set forth in claim 11, the game controller for allowing the player to associate the first token with other of the cell(s) to create additional wager(s).

17. A gaming apparatus, as set forth in claim 11, the game controller for providing a second token corresponding to a second one of the symbols, the second token having an associated second stake and for allowing the player to associate the second token with the first cell, the first wager amount being a function of the first stake if the first token is associated with the first cell and/or a function of the second stake of the second token is associated with the first cell, the wager symbol being the first one of the symbols if only the first token is associated with the first cell, the second one of the symbols if only the second token is associated with the first cell, and a combined symbol if the first and second tokens are associated with the first cell.

18. A gaming apparatus, as set forth in claim 11, the game controller for allowing the player to associate the first token with the one of the cells multiple times, the wager amount being a function of the first stake and the number of times the first token is associated with the one of the cells.

19. A gaming apparatus, as set forth in claim 11, the game controller for allowing the player to modify the first stake.

20. A gaming apparatus, as set forth in claim 11, the game controller for allowing the player to play the game again using the same wager.

21. A method for playing a game, the game including a first cell and a plurality of symbols, the game having an actual result equal to one of the symbols being associated with the first cell, comprising:
providing a first token corresponding to a first one of the symbols, the first token having an associated first stake;
allowing a player to associate the first token with the first cell;
providing a second token corresponding to a second one of the symbols, the second token having an associated second stake;
allowing the player to associate the second token with the first cell;
creating a first wager on the first cell, the first wager having a wager amount and a wager symbol, the wager amount being a function of the first stake if the first token is associated with the first cell and/or a function of the second stake of the second token is associated with the first cell, the wager symbol being the first one of the symbols if only the first token is associated with the first cell, the second one of the symbols if only the second token is associated with the first cell, and a combined symbol if the first and second tokens are associated with the first cell;
playing the game and arriving at an actual result; and,
providing an award to the player, if the actual result is equal to the wager symbol, as a function of the wager amount and a predetermined paytable.

22. A method, as set forth in claim 21, wherein the award is also a function of any cells adjacent to the first cell which have an actual result equal to the wager symbol.

23. A method, as set forth in claim 21, the game including a plurality of cells.

24. A method, as set forth in claim 23, the cells being arranged in a rectangular grid.

25. A method, as set forth in claim 23, each cell representing a reel having a plurality of reel positions, each reel position having an associated one of the symbols.

26. A method as set forth in claim 21, wherein the game is implemented as a video or mechanical slot reel game.

27. A method, as set forth in claim 21, wherein the game is implanted in a computer program playable on a computer.

28. A method, as set forth in claim 21, including the step of allowing the player to modify the first and/or second stake.

29. A method, as set forth in claim 21, including the step of allowing the player to play the game again using the same wager.

30. A method, as set forth in claim 21, including the step of allowing the player to associate the first and/or second token to the first cell multiple times, the wager amount being a function of the number of times the first and/or second token is associated with the first cell.

31. A gaming apparatus for playing a game, the game including a first cell and a plurality of symbols, the game having an actual result equal to one of the symbols being associated with the first cell, comprising:
a display for displaying the game, the game including at least one rotatable reel having a plurality of symbols;
a player interface for providing a first token corresponding to a first one of the symbols, the first token having an associated first stake, and allowing a player to associate the first token with the first cell and for providing a second token corresponding to a second one of the symbols, the second token having an associated second stake, and allowing the player to associate the second token with the first cell; and,
a controller coupled to the display and player interface for creating a first wager on the first cell, the first wager having a wager amount and a wager symbol, the wager amount being a function of the first stake if the first token is associated with the first cell and/or a function of the second stake of the second token is associated with the first cell, the wager symbol being the first one of the symbols if only the first token is associated with the first cell, the second one of the symbols if only the second token is associated with the first cell, and a combined symbol if the first and second tokens are associated with the first cell, for playing the game and arriving at an actual result, and for providing an award to the player, if the actual result is equal to the wager symbol, as a function of the wager amount and a predetermined paytable.

32. A gaming apparatus, as set forth in claim 31, wherein the award is also a function of any cells adjacent to the first cell which have an actual result equal to the wager symbol.

33. A gaming apparatus, as set forth in claim 31, the game including a plurality of cells.

34. A gaming apparatus, as set forth in claim 33, the cells being arranged in a rectangular grid.

35. A gaming apparatus, as set forth in claim 33, each cell representing a reel having a plurality of reel positions, each reel position having an associated one of the symbols.

36. A gaming apparatus as set forth in claim 31, wherein the game is implemented as a video or mechanical slot reel game.

37. A gaming apparatus, as set forth in claim 31, wherein the game is implanted in a computer program playable on a computer.

38. A gaming apparatus, as set forth in claim 31, including the step of allowing the player to modify the first and/or second stake.

39. A gaming apparatus, as set forth in claim 31, including the step of allowing the player to play the game again using the same wager.

40. A gaming apparatus, as set forth in claim 31, including the step of allowing the player to associate the first and/or second token to the first cell multiple times, the wager amount being a function of the number of times the first and/or second token is associated with the first cell.
